(19) United States
(12) Patent Application Publication
(10) Pub. No.: US 2011/0266274 A1
(43) Pub. Date: Nov. 3, 2011

(54) QUARTZ ENCAPSULATED HEATER ASSEMBLY

(76) Inventors: Toshiki Ebata, Osaka-shi (JP); Sridhar R. Prasad, Bangalore (IN); Ajay Rao, Bangalore (IN); Takeshi Higuchi, Kobe (JP); Kensuke Fujimura, Kobe (JP); Akira Miyahara, Ashiya (JP); Eric Witenberter, Beachwood, OH (US)

(21) Appl. No.: 12/312,755

(22) PCT Filed: Nov. 26, 2007
(86) PCT No.: PCT/US2007/024432

§ 371 Date: May 12, 2011

Related U.S. Application Data
(60) Provisional application No. 60/867,397, filed on Nov. 27, 2006.

(51) Int. Cl. H05B 3/68

(52) U.S. Cl. 219/460.1

(57) ABSTRACT

The current invention relates to a semiconductor wafer heater assembly having a frosted clear quartz material for the wafer susceptor (6) that is placed between the heater (8) and the wafer (7) such that at certain wavelengths of the emitted radiant energy from the heater (8), the frosted clear quartz material is ‘thermally transmissive’ to the thermal radiation from the infrared region. The heater assembly is characterized in that the top quartz plate or susceptor (6) on which the wafer (7) is supported is made of a material that is not “optically transmissive” but is more than 90% “thermally transmissive” to infrared emission that is shorter than 3.5 micrometer wavelength and having higher tolerance and mechanical strength than conventional clear quartz material.

### CROSS REFERENCE TO RELATED APPLICATION

This application claims priority to and benefit from U.S. Patent Application No. 60/867,397, filed on Nov. 27, 2006, the disclosure of which is incorporated herein by reference.

### FIELD OF INVENTION

The invention relates generally to a heater and a heating assembly for use in a semiconductor-processing chamber.

### BACKGROUND OF THE INVENTION

Semiconductor Integrated Circuits (IC's) are produced continuously through a series of processes such as thin-film processing, pattern formation, lithography, etching & doping on the surface of a substrate such as a silicon wafer. These IC's can be produced continuously by intermittently introducing the cleaning process in-between. For example, in thin film processing, the deposition process device forms a thin film of the metal and the insulator on the wafer surface. First, the process device is completely evacuated and a heating mechanism is installed within it to heat the silicon wafer to a prescribed temperature. Next, the necessary reactant gases are introduced within the chamber of this device. These gases accumulate around the wafer and a thin-film is formed on the wafer due to the chemical reaction of these gases. The process is completed when the desired film thickness is obtained on the wafer and it is then carried away from the device. In this process, the susceptor (wafer supporting stage) that is present within this device is heated from around 450 Degrees C. to 650 Degrees C. in vacuum conditions and it is at this high temperature that the chemical reaction gets initiated.

In such a process, the surface of the susceptor, or the heater surface or the wiring section that supplies the electricity to the heater are already at high temperatures and when they come in direct contact with the reacting gases it results in chemical reactions that generate certain impurities and these impurities then spread inside the chamber of this device, ultimately resulting in polluting the semiconductor wafer.

One method of overcoming the above problem involves having ceramics such as aluminum nitride (AlN) with a heater electrode and wirings embedded. These ceramic materials are highly resistant to any corrosion medium or material. But ceramics such as AlN are very brittle in nature and frequent heating and cooling of these may result in cracking. Also purity of those ceramics cannot be perfect, as they typically require a binder when being sintered. Further, at higher temperatures of operation the electrical resistance of the ceramic material decreases drastically and this can result in poor insulation of the heaters.

Another method to solve this problem is to encapsulate the heater, susceptor, wiring etc. with a high purity quartz casing. These components are sealed inside an airtight quartz casing and later purged by inert gas. This will mitigate the corrosion of these components by corrosive gases (reactant or cleaning) since quartz material is highly non-reactive in nature. Till recently, the susceptor material that was made out of high purity quartz and were widely used in the silicon wafer thin film processing were restricted mainly to operating temperatures ranging from 450 Degrees C. to 600 Degrees C. However, with recent advances being made to improve the efficiency of IC's through Large Scale Integration (LSI), it has resulted in the requirement of the target wafer temperature for thin film deposition to be in the range of 800 Degrees C. to 900 Degrees C. Also, in such processes that involve very high temperatures, it is observed that the operating temperature of the heater is at least 200 Degrees C. greater than that of the target wafer temperature. This is due to the presence of the prior art quartz material in between the heater and the wafer surface. It is also seen that the temperature of the prior art quartz material itself in these high temperature applications exceeds over 1000 Degrees C. It is known that quartz being an amorphous vitrified structure, its viscosity decreases with temperature and it has a critical viscous or softening point at about 1350 Degrees C.

In other words, the extent by which the temperature of the prior art quartz exceeds 1000 Degrees C., the higher is the plastic deformation of the prior art quartz material. In addition, when the prior art quartz material is cooled down to below 1000 Degrees C., strong thermal strain is set-in and this results in the generation of very high internal stresses within the material. These internal stresses decrease the overall mechanical strength of the material. In most applications, the device chamber is maintained under vacuum conditions whereas the quartz casing that houses the heater and other components is filled by an inert gas. The pressure differential between the inside and the outside of the casing made from the prior art quartz material is usually around 1 atmosphere. This pressure differential is sufficient enough to break the quartz casing since now the quartz plate can no longer withstand the design strength as its strength has been reduced due to the internal stresses developed within the material. This invariably leads to the mechanical deformation of the quartz susceptor, resulting in a poor surface contact between the wafer and the susceptor and, as such, heating of the wafer through thermal conduction is no longer efficient. Hence, for achieving the same wafer temperature, the heater will now need to operate at a much higher temperature.

What is needed in the art is a heater assembly having a susceptor or wafer-supporting stage which when placed between the heater and the wafer does not have issues related to reliability, mechanical deformation and damage even at high operating temperatures and will efficiently heat the semiconductor wafer to the desired target temperature without generating any contaminants.

### SUMMARY OF THE INVENTION

According to one embodiment of the invention, a heater assembly is provided comprising a heating element to heat a wafer to temperatures of at least 700 Degrees C., at least one terminal and wire to feed electrical power to the heater, a thermal insulating plate beneath the heater, at least one feed through hole for the electrical wire and at least one thermo-couple connection, and a quartz casing to encapsulate said components, said quartz casing having a top plate positioned between the heating element and the wafer, wherein said plate comprises a material that is not optically transmissive and is more than about 50 percent thermally transmissive to an infrared emission that is shorter than 3.5 micron wavelength.

### BRIEF DESCRIPTION OF THE DRAWINGS

FIG. 1(a)-(b) presents the transmissivity of the “thermally transmissive” frosted clear quartz material for blackbody thermal radiation at 500 Degrees K and 1500 Degrees K.

FIG. 2 presents a quartz encapsulated heater assembly in which the susceptor is made from frosted clear Quartz material.

FIG. 3 presents a heater assembly used to evaluate the radiative heating efficiency of the various quartz materials

FIG. 4 is a graphical representation of the radiative heating efficiency of Example 1, i.e., Frosted Clear Quartz; Example 2, i.e., Clear Quartz; and Example 3, i.e., High Density Opaque (HDO) Quartz.

### DETAILED DESCRIPTION OF THE INVENTION

As used herein, approximating language may be applied to modify any quantitative representation that may vary without resulting in a change in the basic function to which it is related. Accordingly, a value modified by a term or terms, such as “about” and “substantially,” may not to be limited to the precise value specified, in some cases.

Also as used herein, the “heating apparatus,” may be used interchangeably with “treating apparatus,” “heater,” “electrostatic chuck,” “chuck,” or “processing apparatus,” referring to an apparatus containing at least one heating and/or cooling element to regulate the temperature of the substrate supported thereon, specifically, by heating or cooling the substrate.

As used herein, the term “substrate” refers to the semiconductor wafer or the glass mold being supported/heated by the processing apparatus of the invention. As used herein, the term “sheet” may be used interchangeably with “layer.”

As used herein, the term “circuit” may be used interchangeably with “electrode,” and the term “heating element” may be used interchangeably with “heating electrode,” “electrode,” “resistor,” “heating resistor,” or “heater.” The term “circuit” may be used in either the single or plural form, denoting that at least one unit is present.

The current invention relates to a heater assembly having a new quartz material, i.e., frosted glass quartz, for the wafer susceptor that is placed between the heater and the wafer such that at certain wavelengths of the emitted radiant energy, either in a scattered transmission or direct transmission mode, from the heater this quartz material is “thermally transmissive” to the thermal radiation from the Infrared region (IR). According to one embodiment of the invention the frosted glass quartz is thermally transmissive to at least 50 percent of the IR emission that is shorter than 3.5 micron-meters. According to another embodiment of the invention the frosted glass quartz is thermally transmissive to at least 80 percent of the IR emission that is shorter than 3.5 micron-meters. According to another embodiment of the invention the frosted glass quartz is thermally transmissive to at least 90 percent of the IR emission that is shorter than 3.5 micron-meters.

Frosted clear quartz is defined herein as a quartz material with a roughened surface, the surface roughening being of the dimensions such that it would scatter at least 20 percent, and preferably 50 percent of the visible light. As such, the frosted clear quartz is not optically transmissive. Frosted clear quartz can be prepared, for example, by sandblasting the surface of clear quartz.

In one aspect, the invention relates to a quartz-encapsulated heater, at temperatures higher than 700 Degrees, as the peak of the infrared (IR) emission spectrum from the heater starts shifting towards shorter wavelengths, majority of the IR emission begins to completely transmit through the susceptor which is made of frosted clear quartz material. This is due to the fact that frosted clear quartz susceptor is “thermally transmissive” to the IR emission that is shorter than 3.5 micron-meters and hence most of the emission passes through the frosted clear quartz susceptor directly to the Si wafer. Thus, heating the wafer through the frosted clear quartz susceptor is equivalent to heating the wafer directly without a top plate (susceptor), for example, there is a 10 Degree C. difference between heating a wafer through the frosted clear quartz susceptor and heating a wafer directly without a top plate at 900 degrees C.

Additionally, it is contemplated herein that the frosted clear quartz surface acts to some extent as an “anti-reflection coating/surface” which reduces the amount of IR light that is being reflected back to the heater. In this regard, the frosted clear quartz provides superior heating effects when compared to clear quartz and other types of quartz materials.

The current invention relates to a heater assembly having a frosted clear quartz material for the wafer susceptor that is placed between the heater and the wafer such that at certain wavelengths of the emitted radiant energy from the heater, the frosted clear quartz material is “thermally transmissive” to the thermal radiation from the Infrared region. The desired wafer temperature can now be achieved at almost the same heater temperature as direct heating of the wafer by the heater. Additionally, the presence of the frosted clear quartz top plate prevents the contamination of the heater without compromising the radiative heating efficiency. Also, the frosted clear quartz material possesses better tolerance and mechanical strength than conventional clear quartz material.

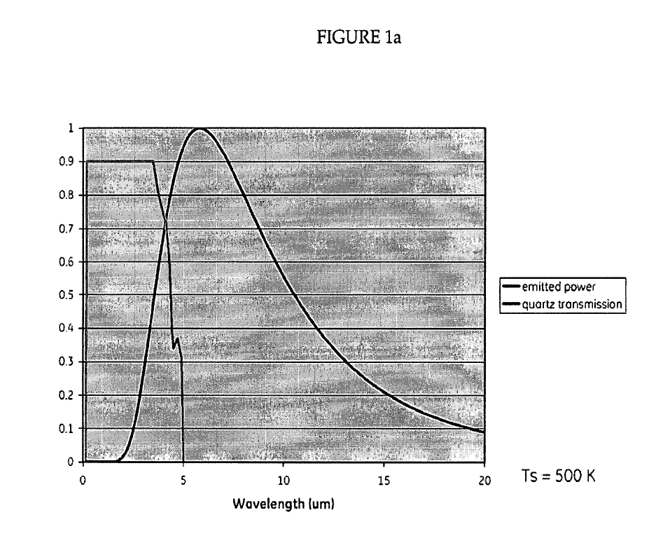

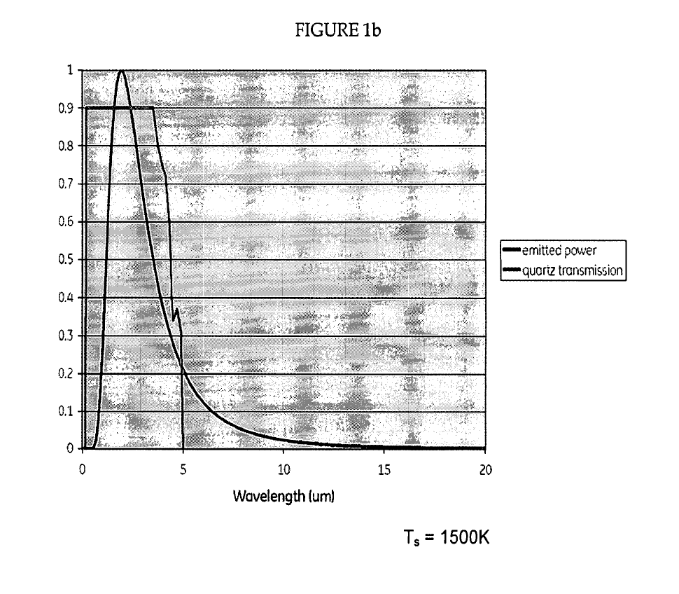

FIGS. 1a and 1b show the relationship between the blackbody spectrum of the object that is heated and the transmissivity of frosted clear quartz for 500 degrees K and 1500 degrees K. Such a quartz material that is so transparent to thermal radiation is normally termed as “thermally transmissive” quartz. From the figure we can conclude that at higher temperatures, the spectrum of the blackbody radiant energy shifts towards the shorter wavelength regime. At 500 degrees K, this “thermally transmissive” quartz does not transmit most of the thermal radiation and is thus sufficiently heated. However, at higher temperatures such as 1500 degrees K, most of the radiant energy gets transmitted through the “thermally transmissive” quartz material. High wafer temperature, i.e., wafer temperatures greater than 700 degrees C. can now be achieved at almost the same heater temperature as direct heating of the wafer by the heater. Importantly, the presence of the frosted clear quartz top plate prevents the contamination of the heater without compromising the radiative heating efficiency. As such, improved efficiency of the radiant energy from the heater to the silicon wafer is obtained when the top quartz plate or the susceptor on which the wafer is supported is made of a material that is at least 50 percent, and preferably more than 90 percent “thermally transmissive” to infrared emission having a wavelength that is shorter than 3.5 micron.

According to one embodiment of the invention, the heater assembly is encapsulated with a top plate quartz or susceptor made out of frosted clear quartz of the present invention. Whereas the lower parts of the quartz casing are made from clear quartz, i.e., quartz material possessing a transparency to visible light of greater than about 80 percent, and the entire casing is made airtight by using techniques known in the art.

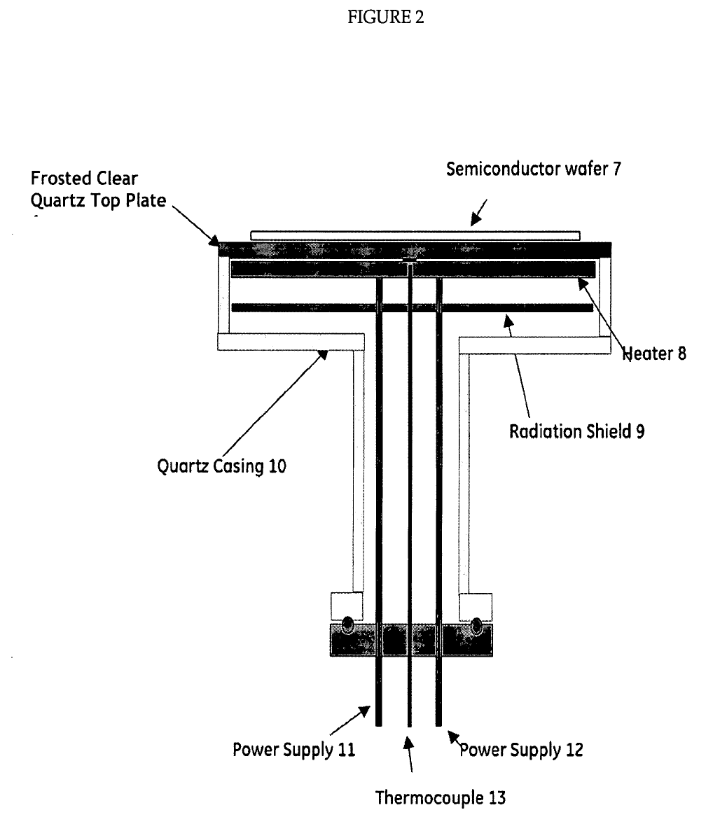

In one specific embodiment of the invention, as presented in FIG. 2, the heater assembly comprises a heater 8, radiation shield 9, heater power supplies 11 and 12 and thermocouple 13 all of which are encapsulated with a top plate or susceptor 6 made out of frosted clear quartz. The lower parts of the quartz casing 10 are made from clear quartz and the entire quartz casing 10 can be made air-tight by techniques known in the art, e.g., bonding.

Examples of a heater assembly with various quartz plates (i.e., Example 1 and Comparative Examples 2 and 3) were prepared to evaluate their radiative heating efficiency. The heater assembly consisted of three main components: A Radiative Heat Source (Pyrolytic Boron Nitride (PBN) Ceramic Heater), A Receiver (an inverted graphite cover) and the quartz plate placed is between the heat source and the receiver.

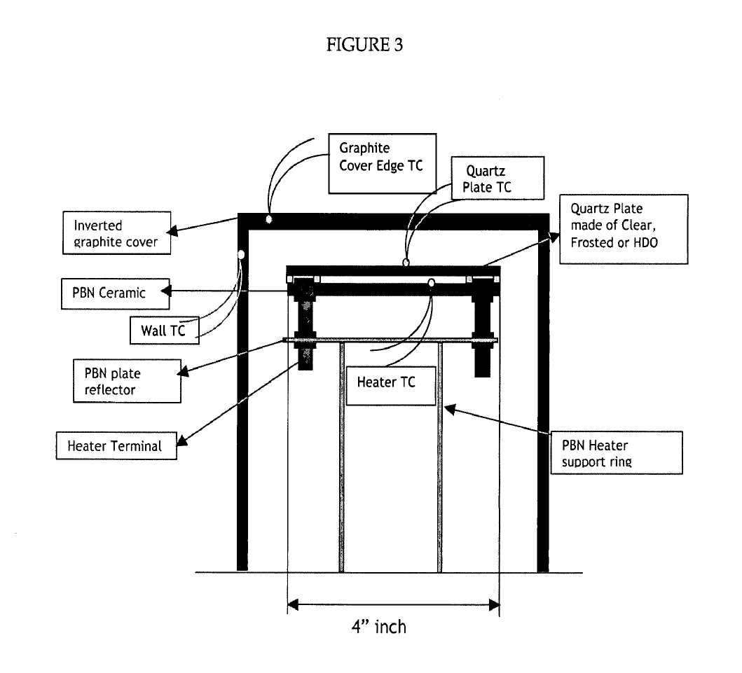

The quartz plate placed between the radiative heater and the graphite receiver in Example 1 is Frosted Clear Quartz, the quartz plate in Comparative Example 2 is Clear Quartz, and in Comparative Example 3 the quartz plate is High Density Opaque (HDO) Quartz, i.e., quartz material having a transparency to visible light of less than about 50 percent, and in most cases a transparency to visible light of less than 20 percent. The heater assembly also consisted of 4 temperature measurement thermocouples. These thermocouples were embedded in specific positions such that they measure the temperature of: the radiant heater, the quartz slab, i.e., quartz plate, the inverted graphite cover center, edge and sidewall. The heater assembly along with a description of the various components and the thermocouple locations is presented in FIG. 3.

Table 1 presents data for Example 1 and Comparative Examples 2 and 3. For a fixed heater temperature, the temperature at the center of the inverted graphite cover is the highest when the quartz plate between the heater and the receiver is made of frosted clear quartz. As represented by the data presented in Table 1 the radiative heating efficiency (highest to lowest) is as follows: Frosted Clear Quartz, Clear Quartz, HDO Quartz.

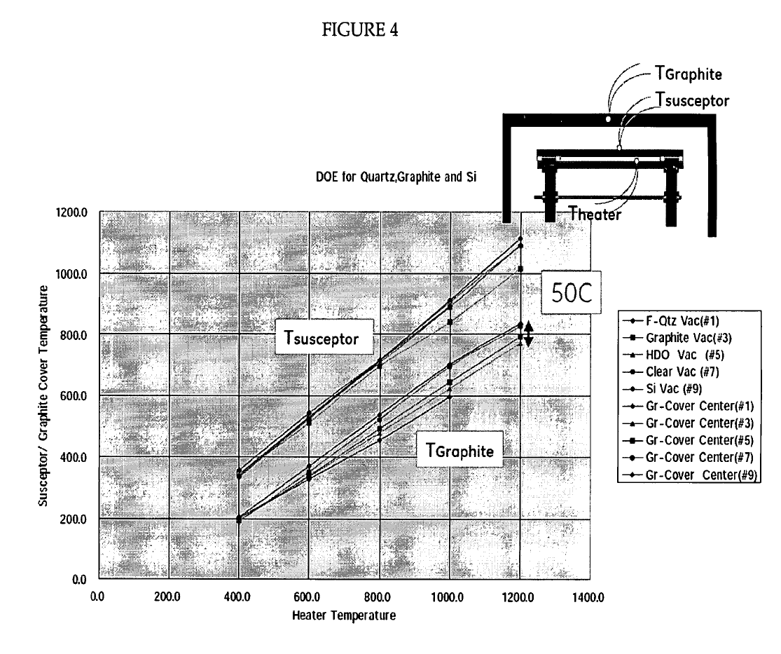

FIG. 4 is a graphically representation of the radiative heating efficiency of the materials of Example 1 (Frosted Clear Quartz), Comparative Example 2 (Clear Quartz), and Comparative Example 3 (High Density Opaque (HDO) Quartz). Based on the data presented in FIG. 4, it can be noted that to achieve a fixed wafer temperature the required heater temperature is lower when the top plate is made of either frosted clear quartz or clear quartz as compared to HDO quartz. Additionally, the better tolerance and mechanical strength of frosted clear quartz makes it a more suitable material for the outer quartz casing.

Table 1 presents the experimental data of Example ! and Comparative examples 2 and 3. Temperature in Centigrade (TC).

| | | | | (Ex. 1) | (CompEx 2) | (CompEx 3) |
|---|---|---|---|---|---|---|
| | Example 1 | Comp. Ex. 2 | Comp. Ex. 3 | Graphite Cover | Graphite Cover | Graphite Cover |
| Heater TC | Frosted Quartz TC | Clear Quartz TC | HDO Quartz TC | TC (Frosted) | TC (Clear) | TC (HDO) |
| 400.0 | 340.8 | 335.8 | 343.4 | 204.5 | 191.3 | 192.1 |
| 600.0 | 530.0 | 525.8 | 528.7 | 371.4 | 351.4 | 339.6 |
| 800.0 | 715.9 | 712.5 | 707.0 | 536.6 | 521.0 | 492.9 |
| 1000.0 | 912.0 | 905.9 | 889.7 | 701.1 | 692.7 | 643.7 |
| 1200.0 | 1112.9 | 1088.2 | 1091.2 | 835.3 | 825.4 | 791.7 |

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. All citations referred herein are expressly incorporated herein by reference.

1. A heater assembly comprising a heating element to heat a wafer to temperatures of at least 700 Degrees C., at least one terminal and wire to feed electrical power to the heater, a thermal insulating plate beneath the heater, at least one feed through hole for the electrical wire and at least one thermo-couple connection, and a quartz casing to encapsulate said components, said quartz casing having a top plate positioned between the heating element and the wafer, wherein said plate comprises a material that is not optically transmissive and is more than 50 percent thermally transmissive to an infrared emission that is shorter than 3.5 micron wavelength.

2. The heater assembly of claim 1, wherein the top plate comprises frosted clear quartz.

3. The heater assembly of claim 2, wherein the frosted clear quartz has thermal transmissivity of at least 80 percent.

4. The heater assembly of claim 2, wherein the frosted clear quartz has thermal transmissivity of at least 90 percent.

5. The heater assembly of claim 1, wherein all the components inside the quartz casing are completely isolated from the chamber environment by sealing the top plate and quartz casing by bonding.

6. The heater assembly of claim 1, wherein the top plate is made of frosted clear quartz and fusion bonded to the quartz casing.

7. The heater assembly of claim 1, wherein the quartz casing other than the top plate is prepared from clear quartz.

8. The heater assembly of claim 1, wherein the top plate is more than 50 percent thermally transmissive to an infrared emission that is shorter than 3.2 micron wavelength.

9. The heater assembly of claim 1, wherein the top plate is more than 80 percent thermally transmissive to an infrared emission that is shorter than 3.2 micron wavelength.

10. The heater assembly of claim 1, wherein the top plate is more than 90 percent thermally transmissive to an infrared emission that is shorter than 3.2 micron wavelength.

11. A semiconductor processing chamber comprising the heater assembly of claim 1.
